(19) United States
(12) Patent Application Publication
(10) Pub. No.: US 2024/0164359 A1
(43) Pub. Date: May 23, 2024

(54) Shape-memory Alloy (SMA) Wire for Fishing Tackles, a Fishing Cork, and an Apparatus for Fishing Thereof

(71) Applicant: Expertackle Inc., Edmonton (CA)

(72) Inventor: Baoquan ZHU, Jieshou (CN)

(21) Appl. No.: 17/989,384

(22) Filed: Nov. 17, 2022

(51) Int. Cl. A01K 91/04; A01K 93/00

(52) U.S. Cl. CPC A01K 91/04; A01K 93/00

(57) ABSTRACT

A shape-memory alloy (SMA) wire for fishing corks, including an SMA wire body; a first end extending along a first direction of the SMA wire body; and a second end extending along a second direction opposite to the first direction; wherein: the SMA wire forms a first annular part at the first end and a second annular part at the second end; both the first annular part and the second annular part are subject to heat treatment; the first annular part and the second annular part are configured to bear a first tensile force prior to the heat treatment; the first annular part and the second annular part are configured to bear a second tensile force subsequent to the heat treatment; and the second tensile force is at least 100% greater than the first tensile force.

### TECHNICAL FIELD

The present disclosure relates to the field of fishing tackles, and more particularly to a shape-memory alloy (SMA) wire for fishing tackles, a fishing cork, and an apparatus for fishing thereof.

### BACKGROUND

In the field of fishing tackles, steel wire has been used in fishing gear. Typically, a fishing cork (also called float/bobber) comprises steel wire passing through the bead and fishing cork body. However, after repeated use, the steel wire may become deformed, resulting in complete loss of function of the fishing cork.

Thus, a shape-memory alloy (SMA) wire is gradually being used for fishing corks. The most common shape-memory alloy wire is nickel-titanium alloy wire. However, although the strength and deformability of the wire body are significantly improved compared with the steel wire, the annular or hook-shaped end connecting other fishing gear is still easy to break.

Therefore, a heretofore unaddressed need exists in the art to address the aforementioned deficiencies and inadequacies.

### SUMMARY

To solve the technical problems above, the present disclosure provides a shape-memory alloy (SMA) wire for fishing tackles, comprising:
a shape-memory alloy wire body;
a first end extending along a first direction of the wire body; and
a second end extending along a second direction opposite to the first direction;
wherein,
the shape-memory alloy wire forms a first annular part at the first end and a second annular part at the second end, wherein,
both the first and second annular parts are subjected to additional heat treatment compared with the wire body, and
the tensile force that each heat-treated part can bear is increased by at least about 100% compared with that before heat treatment.

In addition, the shape-memory alloy wire is nickel-titanium (NiTi) alloy wire.

In addition, the diameter of the wire is 1 to 2 mm.

In addition, the tensile force that each heat-treated part can bear is between 55 and 190 lbs.

In addition, the tensile force that each heat-treated part can bear is increased by about 150% compared with that before heat treatment.

In addition, any annular part is formed by the wire bent along an annular part and is fixed with the wire body through a fastener.

In addition, any annular part is formed by the wire bent along an annular part and is wound on the wire body so as to be fixed with the wire body.

In addition, the fastener is hollow and encloses the end of any annular part and the wire body.

In addition, when the diameter of the wire is 1 mm, under the condition of ten samples testing:
before heat treatment, the tensile force that each annular part can bear is 27.8 to 36.6 lbs., and
after heat treatment, the tensile force that each annular part can bear is 58.9 to 71.2 lbs.

In addition, when the diameter of the wire is 2 mm, under the condition of ten samples testing:
before heat treatment, the tensile force that each annular part can bear is 72.4 to 92.8 lbs., and
after heat treatment, the tensile force that each annular part can bear is 144.7 to 188.2 lbs.

In addition, when the diameter of the wire is 1.2 mm, under the condition of ten samples testing:
before heat treatment, the tensile force that each annular part can bear is 34.4 to 41.5 lbs., and
after heat treatment, the tensile force that each annular part can bear is 90.8 to 99.7 lbs.

In addition, the present disclosure further provides a fishing cork, comprising:
the shape-memory alloy wire mentioned above;
cork body passing through the shape-memory alloy wire; and
multiple beads passing through the shape-memory alloy wire.

In addition, the shape-memory alloy wire is nickel-titanium (NiTi) alloy wire.

In addition, the fishing cork further comprising:
fishing counterweight passing through the shape-memory alloy wire.

In addition, after the shape-memory alloy wire passes through at least a first bead, the cork body and a second bead in turn, the first annular part and the second annular part are heat treated.

Furthermore, the present disclosure discloses an apparatus for fishing, comprising:
the shape-memory alloy wire mentioned above.

Through the technical solutions above, when the shape-memory alloy wire at the each end of the wire body is shaped into an annular part, the present disclosure further improves toughness and the tensile strength of each annular part at the both ends by the use of additional heat treatment compared with the wire body.

### BRIEF DESCRIPTION OF THE DRAWINGS

The accompanying drawings illustrate one or more embodiments of the present disclosure and, together with the written description, serve to explain the principles of the present disclosure. Wherever possible, the same reference numbers are used throughout the drawings to refer to the same or like elements of an embodiment.

FIG. 1 is a schematic diagram of a shape-memory wire in an embodiment of the present disclosure;

FIG. 2 is a partially enlarged schematic diagram of one end of a shape-memory wire in an embodiment of the present disclosure;

FIG. 3 is a partially enlarged schematic diagram of one end of a shape-memory wire in an embodiment of the present disclosure;

FIG. 4A is the schematic diagram of a fishing cork in an embodiment of the present disclosure;

FIG. 4B is the schematic diagram of a fishing cork in an embodiment of the present disclosure.

FIG. 5 is a first configuration of a fishing cork in an embodiment of the present disclosure.

FIG. 6 is a second configuration of a fishing cork in an embodiment of the present disclosure.

FIG. 7 is a flowchart of an exemplary heat-treating process in an embodiment of the present disclosure.

FIG. 8 is an exemplary table illustrating properties of a shape-memory wire in an embodiment of the present disclosure.

### DETAILED DESCRIPTION

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting and/or capital letters does not influence the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the disclosure or any exemplified term. Likewise, the disclosure is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or a section. Thus, a first element, component, region, layer, or section discussed below can be termed a second element, component, region, layer, or section without departing from the teachings of the present disclosure.

It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with, or “directly contacting” another element, there are no intervening elements present. It is also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It is understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated. In this present disclosure, the dimension with the term “about” is within 5 percent of a give value or range.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in a different order (or concurrently) without altering the principles of the disclosure.

Embodiments of the disclosure are illustrated in detail hereinafter with reference to accompanying drawings. It should be understood that specific embodiments described herein are merely intended to explain the disclosure, but not intended to limit the disclosure. In accordance with the purposes of this disclosure, as embodied and broadly described herein, this disclosure, in certain aspects, relates to a shape-memory alloy (SMA) wire for fishing tackles, a fishing cork, and an apparatus for fishing thereof and applications of the same.

To provide a more comprehensive illustration of the embodiments of the present disclosure, a plurality of details will be expounded infra. However, to those skilled in the art, it is apparent that the embodiments of the present disclosure may be implemented without these details. In addition, the features in different embodiments described infra may be combined with one another, unless otherwise specifically indicated.

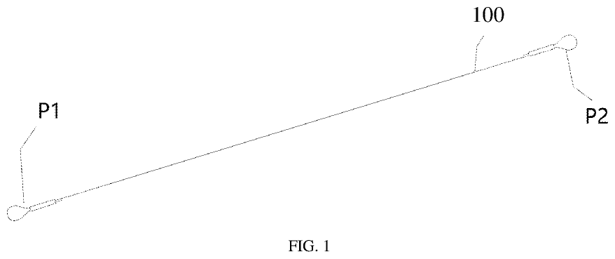

Referring to FIG. 1, in one embodiment, the present disclosure provides a shape-memory alloy (SMA) wire for fishing tackles, comprising:
a shape-memory alloy wire body (100);
a first end extending along a first direction of the wire body; and
a second end extending along a second direction opposite to the first direction;
wherein,
the shape-memory alloy wire forms a first annular part (P1) at the first end and a second annular part (P2) at the second end, wherein,
both the first and second annular parts are subjected to additional heat treatment compared with the wire body, and
the tensile force that each heat-treated part can bear is increased by at least about 100% compared with that before heat treatment.

Compared with the traditional steel wire and the titanium alloy wire in the prior art, the shape-memory alloy wire provided in the present disclosure not only ensures the strength and deformability of the wire body but also improves the tensile strength of each annular part by the use of additional heat treatment compared with the wire body. As disclosed, the wire body and both annular parts are treated differently, wherein the two annular parts are additionally heat treated compared with the wire body. In this way, as a shape-memory alloy wire for fishing corks, it not only ensures the strength and deformability of the wire body but also overcomes the defect that both ends of the traditional titanium wire are easy to break. Therefore, the shape-memory alloy wire can be widely used for fishing corks, and each annular part of which can be firmly, reliably, and durably connected with other fishing gear, while the wire body maintains flexibility, deformation ability, and strength.

In the present embodiment, heat treatment includes annealing, normalizing, hardening, aging, stress relieving, tempering, and carburization.

In another embodiment, the shape-memory alloy wire is nickel-titanium (NiTi) alloy wire.

The present embodiment may utilize different kinds of shape-memory alloy, but nickel-titanium alloy is preferably used.

It should be noted that, because the weight of common saltwater fish is about 20 pounds, and the instantaneous tension of the fish during fishing can reach 40 to 50 pounds, considering that the minimum bearing tension of nickel-titanium wire used for fishing is about 25 pounds, the present disclosure needs to increase the bearing tension of each annular part by at least 100%.

In addition, the diameter of the wire is about 1 to 2 mm.

In another embodiment, the tensile force that each heat-treated part can bear is between 55 and 190 lbs.

It should be explained that the consideration of about 55 to 190 lbs. is based on the weight of ordinary fish and the instantaneous pulling force of 2 to 4 times its weight. Therefore, this range of values from about 55 to 190 lbs. is carefully selected.

The tensile force that each heat-treated part can bear is increased by about 150% compared with that before heat treatment. A particular heat-treating process is used to increase the tensile force that each heat-treated part can bear. The heat-treating process includes heating the wire to a certain temperature, bending the wire into shape, and quenching the wire, such that the natural form of the wire is changed, thus increasing the tensile force that the wire can bear.

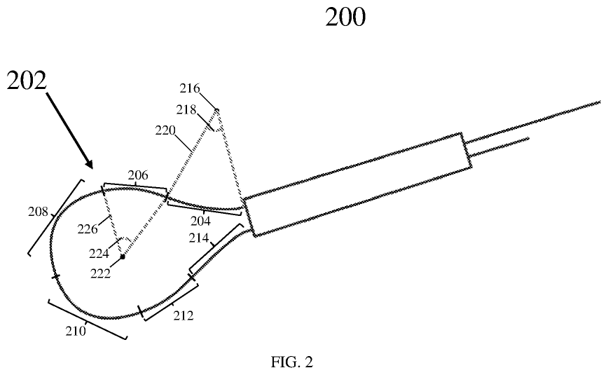

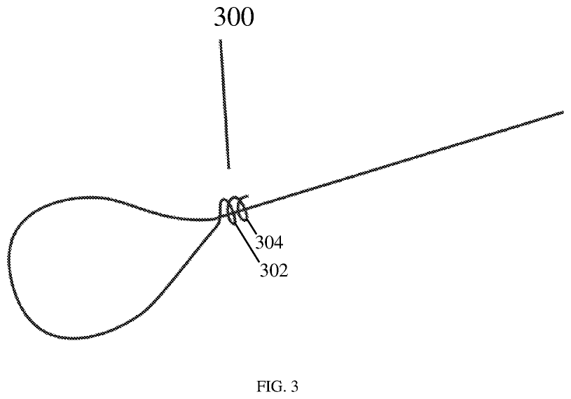

Specifically, the heat-treating process includes heating the wire to the critical range of 600-1400° C. Once the wire is in the critical range, the wire will turn red. If above the critical range, the wire will be brightly red, indicative of the wire melting, and will not result in the desired increase in tensile strength. In one embodiment, a blowtorch may be used to heat the wire until the wire turns red before twisting the wire into the desired shape. The wire may be placed on a heat-resistant brick before heat is applied using the blowtorch. As will be appreciated by one skilled in the art, alternative heating devices may be used to heat the wire to a temperature in the critical range. The time it takes to reach a temperature in the critical range may be 2-3 seconds, depending on the thickness of the wire. Once the wire is in the critical range, the wire may be twisted into shape (such as the shapes shown in FIGS. 2-3) and quenched in a quenching medium, such as, but not limited to, oil, water, air, etc. In the preferred embodiment, the quenching medium is oil.

If the temperature is lower than 600° C., the wire will not be able to maintain its shape, and the tensile force that the wire can bear will be reduced. If the temperature is greater than 1400° C., the wire will melt and will not maintain the features of a titanium wire. In particular, the tensile strength of a wire heated to a temperature of greater than 1400° C. will be worse than even a stainless-steel wire. The temperature ranges from 600° C. to 1400° C. is critical. The range is critical, because the range achieves unexpected results relative to the prior art range. The tensile force that each heat-treated part can bear is increased by about 150% compared with that before heat treatment.

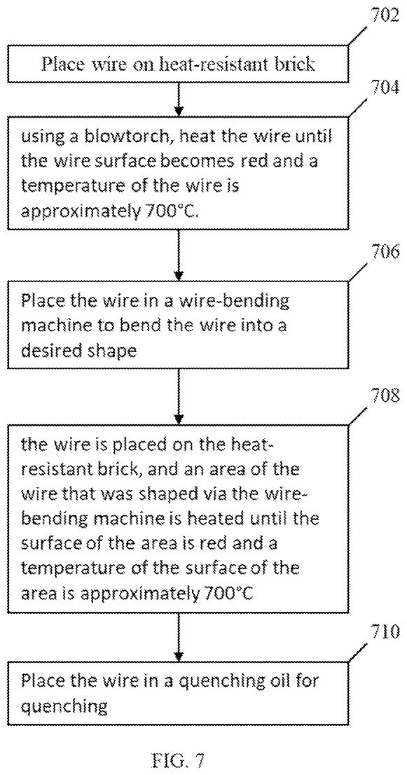

With reference to FIG. 7, an exemplary heat-treating process is described. In a step 702, a wire is placed on a heat-resistant brick. In a step 704, using a blowtorch, the wire is heated until the wire surface becomes red and a temperature of the wire is preferably approximately 700° C. In a step 706, the wire is placed in a wire-bending machine to bend the wire into a desired shape. In a step 708, the wire is placed on the heat-resistant brick, and an area of the wire that was shaped via the wire-bending machine is heated until the surface of the area is red and a temperature of the surface of the area is preferably approximately 700° C. In a step 710, the wire is placed in a quenching oil for quenching. With this heat-treating process, the product of the present disclosure is significantly different than the prior art even though the structure of the product can be different. Specifically, the tensile force that each heat-treated part can bear is increased by about 150% compared with that before heat treatment.

Referring to FIG. 2, in another embodiment, any annular part is formed by the wire bent along an annular part and is fixed with the wire body through a fastener (200). The particular shape of loop 202 in FIG. 2 is critical to the tensile strength of the SMA wire. Loop 202 includes first section 204, second section 206, and third section 208, fourth section 210, fifth section 212, and sixth section 214. The sections of loop 202 are arcs, each with an individual radius, angle, and arc length. As will be appreciated by one skilled in the art, the radius and angle of first section 204 and second section 206 are shown in FIG. 2 using dashed lines and are for illustrative purposes only. The radius and angle of third section 208, fourth section 210, fifth section 212, and sixth section 214 are omitted from FIG. 2 for clarity of the figure. It should be noted that first section 204 and sixth section 214 are arcs with an origin external to loop 202 (e.g., first origin 216), while second section 206, third section 208, fourth section 210, and fifth section 212 are arcs with an origin internal to loop 202 (e.g., origin 222). The first, second and third section are symmetrical or substantially symmetrical to the sixth, fifth and forth sections, respectively. The second section and the third section can share a first same origin and the fourth and fifth sections can share a second same origin. The first same origin and the second same origin can be the same.

In one embodiment, the first, second, fifth and sixth sections each have an acute angle. The third and fourth sections each have an obtuse angle. The acute angle is in a range of lower than 60 degrees and the obtuse angle is in a range of not higher than 120 degrees.

In one embodiment, a total length of loop 202 is about 15.8 mm First section 204 is a first arc with first radius 220 measuring about 3.3 mm and first angle 218 measuring about 45.9 degrees, and thus has a first arc length of about 2.7 mm Second section 206 is a second arc with second radius 226 measuring about 2.6 mm and second angle 224 measuring about 48.4 degrees, and thus has a second arc length of about 2.2 mm Third section 208 is a third arc with a third radius measuring about 1.8 mm and a third angle measuring about 95.6 degrees, and thus has a third arc length of about 3.0 mm.

Fourth section 210, fifth section 212, and sixth section 214 mirror third section 208, second section 206, and first section 204, respectively, and have substantially similar radiuses, angles, and arc lengths.

In this present disclosure, the dimension with the term “about” is within 5 percent of a give value or range. For example, the first radius 220 measures about 3.3 mm (i.e., 3.3±0.1 mm). The particular dimensions of loop 202 are critical in achieving the unexpected result of increased tensile strength of the SMA wire.

Referring to FIG. 3, in another embodiment, any annular part is formed by the wire bent along an annular part and is wound on the wire body so as to be fixed with the wire body.

In FIG. 3, reference character 300 shows the structure of the winding.

In another embodiment, the fastener is hollow and encloses the end of any annular part and the wire body.

In another embodiment, when the diameter of the wire is 1 mm, under the condition of ten samples testing:
before heat treatment, the tensile force that each annular part can bear is 27.8 to 36.6 lbs., and
after heat treatment, the tensile force that each annular part can bear is about 58.9 to 71.2 lbs.

In another embodiment, when the diameter of the wire is 2 mm, under the condition of ten samples testing:
before heat treatment, the tensile force that each annular part can bear is about 72.4 to 92.8 lbs., and
after heat treatment, the tensile force that each annular part can bear is about 144.7 to 188.2 lbs.

In another embodiment, when the diameter of the wire is 1.2 mm, under the condition of ten samples testing:
before heat treatment, the tensile force that each annular part can bear is about 34.4 to 41.5 lbs., and
after heat treatment, the tensile force that each annular part can bear is about 90.8 to 99.7 lbs.

For example, the test results of ten shape-memory alloy wire samples are as follows:
before heat treatment, the tensile force that each annular part can bear are about 34.4, 35.8, 35.2, 36.3, 37.1, 39.6, 41.5, 36, 33.5, and 38 lbs., and the average tensile force is about 36.74 lbs.;
after heat treatment, the tensile force that each corresponding annular part can bear is about 92.7, 94.8, 98.9, 99.7, 91.3, 96.2, 90.8, 97.3, 91.4, and 97.1 lbs., and the average tensile force is about 95.02.

(95.02−36.74)/36.74=158.6%.

It is understood that the tensile force that each heat-treated part can bear is increased by about 150% compared with that before heat treatment.

Under the same conditions, for nickel-titanium alloy wires with diameters of 1 mm, 1.2 mm, 1.3 mm, 1.4 mm, 1.5 mm, 1.6 mm, 1.7 mm, 1.8 mm, 1.9 mm and 2 mm, the tensile force that the annular part can bear is roughly proportional to the increase in diameter.

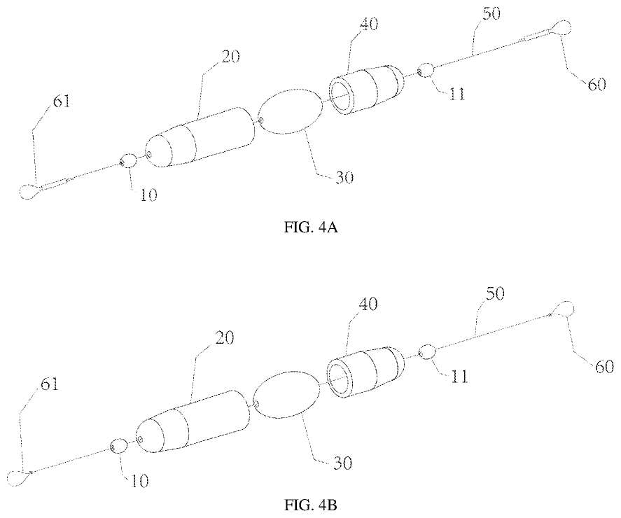

Referring to FIG. 4A, in another embodiment, the present disclosure further provides a fishing cork, comprising:
the shape-memory alloy wire (50);
cork body (30) passing through the shape-memory alloy wire; and
multiple beads (10, 11) passing through the shape-memory alloy wire.

Referring to FIG. 4A, in another embodiment, any annular part is formed by the wire bent along an annular part and is fixed with the wire body through a fastener.

Referring to FIG. 4B, in another embodiment, any annular part is formed by the wire bent along an annular part and is wound on the wire body so as to be fixed with the wire body.

It should be understood that in the present embodiment, the size, color, and material of beads or fishing cork bodies can be changed according to the needs of the user. Similarly, the size, shape, weight (such as ⅜ oz, ½ oz, ¾ oz, 1 oz, etc.), and material (such as lead, brass, stainless steel, etc.) of counterweights can also be changed according to the needs of the user.

Exemplary fishing cork body shapes may be Oval, Cannon, 3″ Cone, 2″ Cone, 4″ Cone, etc. Similarly, the diameter of the bead may be 6 mm, 8 mm, 10 mm, 16 mm, etc. The material of the bead may be ABS, Acrylic, brass, stainless steel, etc.

In one embodiment, the fishing cork body may include a plastic bottom, wherein the fishing cork body is cupped at one end such that, once pulled abruptly by the user, the fishing cork body produces a distinct sound and disrupts the surface of the water to attract fish.

In another embodiment, the shape-memory alloy wire is nickel-titanium (NiTi) alloy wire.

Preferably, the diameter of the nickel-titanium alloy wire is 1.2 mm, and the length is 6.75 inches.

In another embodiment, the fishing cork further comprises:
fishing counterweight (20 and/or 40) passing through the shape-memory alloy wire.

In another embodiment, referring to FIG. 4A:
after the shape-memory alloy wire passes through at least a first bead (10), the cork body (30), and a second bead (11) in turn, the first annular part (61) and the second annular part (60) are heat treated.

The first annular part (61) and the second annular part (60) may have the structure of loop 202 shown and described above with reference to FIG. 2.

Furthermore, the present disclosure discloses an apparatus for fishing, comprising:
the aforementioned shape-memory alloy wire.

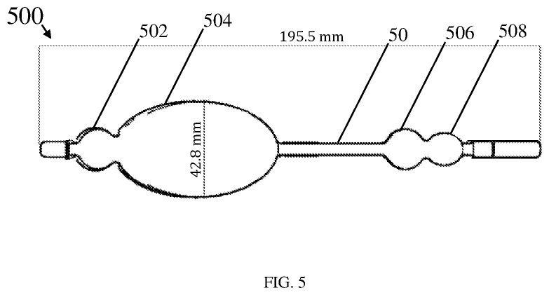

In another embodiment, referring to FIG. 5:
a fishing cork (500) includes the shape-memory alloy wire (50) passing through a first bead (502), a cork (504), a second bead (506), and a third bead (508).

In particular, the cork (504) may be of an ovular shape with a diameter of about 42.8 mm, and a length of the fishing cork (500) is about 195.5 mm.

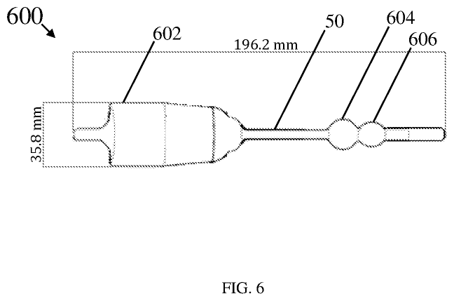

In another embodiment, referring to FIG. 6:
a fishing cork (600) includes the shape-memory alloy wire (50) passing through a cork (602), a first bead (604), and a second bead (606).

In particular, the cork (602) may be of an irregular shape with a diameter of 35.8 mm, and a length of the fishing cork (600) is 196.2 mm.

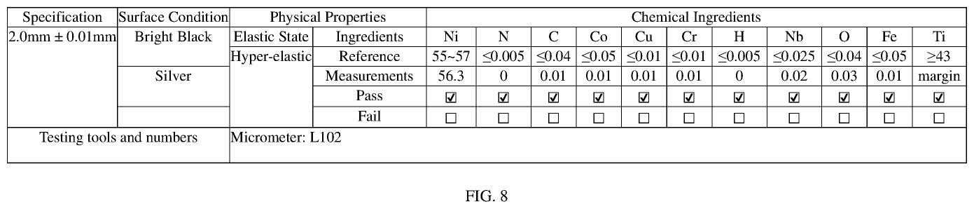

FIG. 8 is an exemplary table illustrating properties of a shape-memory wire in an embodiment of the present disclosure. As shown in FIG. 8, in one embodiment, the shape-memory alloy wire may be an alloy of Nickel (Ni), Nitrogen (N), Carbon (C), Cobalt (Co), Copper (Cu), Chromium (Cr), Hydrogen (H), Niobium (Nb), Oxygen (O), Iron (Fe), and Titanium (Ti), with a vast majority of the composition being Ni and Ti. Specifically, in one embodiment the shape-memory alloy wire may be composed of 55-57% Nickel, ≤0.005% Nitrogen, ≤0.04% Carbon, ≤0.05% Cobalt, 0.01% Copper, ≤0.01% Chromium, ≤0.005% Hydrogen, ≤0.025% Niobium, ≤0.04% Oxygen, ≤0.05% Iron, and ≥43% Titanium.

The embodiments above only schematically illustrate the principle of the present disclosure. It should be understood that the modifications and alterations of the arrangements and the details described herein will be obvious to those skilled in the art. Therefore, the present disclosure is not intended to be limited by the scope of the claims, not limited to the specific details of the present disclosure provided to illustrate and describe the embodiments.

The embodiments were chosen and described to explain the principles of the disclosure and their practical application to activate others skilled in the art to utilize the disclosure and various embodiments with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A shape-memory alloy (SMA) wire for fishing corks, comprising:
an SMA wire body;
a first end extending along a first direction of the SMA wire body; and
a second end extending along a second direction opposite to the first direction; wherein:
the SMA wire forms a first annular part at the first end and a second annular part at the second end;
both the first annular part and the second annular part are subject to heat treatment;
the first annular part and the second annular part are configured to bear a first tensile force prior to the heat treatment;
the first annular part and the second annular part are configured to bear a second tensile force subsequent to the heat treatment; and
the second tensile force is at least 100% greater than the first tensile force.

2. The SMA wire according to claim 1, wherein the shape-memory alloy wire is nickel-titanium (NiTi) alloy wire.

3. The SMA wire according to claim 2, wherein the shape-memory alloy wire has a diameter, and the diameter of the wire is 1 to 2 mm.

4. The SMA wire according to claim 3, wherein the second tensile force is between 55 and 190 lbs.

5. The SMA wire according to claim 4, wherein the second tensile force of the shape-memory alloy wire is at least 150% greater than the first tensile force.

6. The SMA wire according to claim 5, wherein at least one of the first annular part and the second annular part are formed by the SMA wire bent along an annular part and is fixed with the SMA wire body through a fastener.

7. The SMA wire according to claim 5, wherein at least one of the first annular part and the second annular part is formed by the SMA wire bent along an annular part and wound on the SMA wire body so as to be fixed with the SMA wire body.

8. The SMA wire according to claim 6, wherein the fastener is hollow and encloses an end of at least one of the first annular part and the second annular part, and the wire body.

9. The SMA wire according to claim 2, wherein the first tensile force is 27.8 to 36.6 lbs., and the second tensile force that each annular part can bear is 58.9 to 71.2 lbs.

10. The SMA wire according to claim 2, wherein, the first tensile force is 72.4 to 92.8 lbs., and the second tensile force is 144.7 to 188.2 lbs.

11. The SMA wire according to claim 2, wherein, the first tensile force is 34.4 to 41.5 lbs., and the second tensile force is 90.8 to 99.7 lbs.

12. A fishing cork, comprising:
the SMA wire according to claim 1;
a cork body that the SMA wire passes through;
a fishing counterweight passing through the SMA wire; and
multiple beads passing through the SMA wire.

13. The fishing cork according to claim 12, wherein the SMA wire is nickel-titanium (NiTi) alloy wire.

14. The fishing cork according to claim 12, wherein after the SMA wire passes through at least a first bead of the multiple beads, the cork body, and a second bead of the multiple beads in turn, the first annular part and the second annular part are heat treated.

15. The fishing cork according to claim 14, wherein the cork body is an ovular shape with a diameter of about 42.8 mm, and a length of the fishing cork is about 195.5 mm.

16. The fishing cork according to claim 14, wherein the cork body is an irregular shape with a diameter of about 35.8 mm, and a length of the fishing cork is about 196.2 mm.

17. The SMA wire according to claim 5, comprising: 55-57% Nickel, ≤0.005% Nitrogen, ≤0.04% Carbon, ≤0.05% Cobalt, ≤0.01% Copper, ≤0.01% Chromium, 0.005% Hydrogen, 0.025% Niobium, ≤0.04% Oxygen, ≤0.05% Iron, and ≥43% Titanium.

18. The SMA wire according to claim 17, wherein the heat treatment comprises:
mounting the SMA wire;
heating the SMA wire to a temperature between 600° C.-1400° C.;
bending the SMA wire to form the first annular part and the second annular part;
heating the first annular part and the second annular part to a temperature between 600° C.-1400° C.; and
quenching the SMA wire.

19. The SMA wire according to claim 1, wherein the first annular part and the second annular part each comprise an identical loop structure;
the loop structure comprises a first section, a second section, a third section, a fourth section, a fifth section, and a sixth section;
the first section and the fourth sixth section each comprise an origin external to the loop structure; and
the second section, the third section, the fourth section, and the fifth section each comprise an origin internal to the loop structure.

20. The SMA wire according to claim 19, wherein:
the first section is a first arc with a first radius measuring about 3.3 mm and a first angle measuring about 45.9 degrees, and thus has a first arc length of about 2.7 mm;
the second section is a second arc with a second radius measuring about 2.6 mm and a second angle measuring about 48.4 degrees, and thus has a second arc length of about 2.2 mm;
the third section is a third arc with a third radius measuring about 1.8 mm and a third angle measuring about 95.6 degrees, and thus has a third arc length of about 3.0 mm; and
the fourth section, the fifth section, and the sixth section mirror the third section, the second section, and the first section, respectively.
